(19) United States
(12) Patent Application Publication
(10) Pub. No.: US 2003/0115168 A1
(43) Pub. Date: Jun. 19, 2003

(54) Methods and apparatus for database transaction queuing

(76) Inventor: Terry Robison, Citrus Heights, CA (US)

Correspondence Address: HEWLETT-PACKARD COMPANY, Intellectual Property Administration, P.O. Box 272400, Fort Collins, CO, 80527-2400, US

(21) Appl. No.: 10/022,787

(22) Filed: Dec. 17, 2001

(51) Int. Cl. G06F 7/00

(52) U.S. Cl. 707/1

(57) ABSTRACT

A method for optimizing database transaction performance in a database transaction processor having transaction services threads capable of being in active, non-active, and waiting states. The method includes: (a) adding a database change to a top of a queue; and (b) starting a non-active transaction service thread conditioned upon less than a predetermined maximum number of transaction service threads being present.

### FIELD OF THE INVENTION

The present invention relates to methods and apparatus for orderly access to a database or database server, and more particularly to methods and apparatus for queuing of database transactions for a transaction system having multiple transaction service threads.

### BACKGROUND OF THE INVENTION

In some database systems, users enter transactions to manipulate the contents of the database. Each transaction is prepared by a user, which requires that users handle the overhead of constructing and submitting the transactions. This overhead varies depending upon which database interface is being used, and can range from non-existent or minimal to significant. At least one known database system includes a database abstraction layer that has a moderate level of overhead associated with it. This database system is built upon a Java® JDBC interface and requires that each separate transaction on the database take place in a thread within a separate Java ThreadGroup. Setting up a transaction involves designating an appropriate Thread within a ThreadGroup or starting Thread within an appropriate Threadgroup, signaling the beginning of a transaction and handling any error conditions from possible failures to get a correct context and/or from network failures, and clearing a cache of a connection if it has been used previously to prevent the possibility of reading out-of-date values from the cache. In addition to the set up overhead, there is also overhead associated with handling of failed transactions. This overhead includes committing the transactions after all database changes are completed, dealing with possible errors by writing to a log file and notifying interested listeners, and rolling back any changes if necessary. In addition, transactions are processed as the users submit them. Thus, it is possible to overwhelm the database with a large quantity of nearly simultaneous transactions.

### SUMMARY OF THE INVENTION

To better manage the resources of databases and to avoid overwhelming databases with large numbers of nearly simultaneous transactions, one configuration of the present invention provides a method for optimizing database transaction performance in a database transaction processor having transaction services threads capable of being in active, nonactive, and waiting states. The method includes: (a) adding a database change to a top of a queue; and (b) starting a non-active transaction service thread conditioned upon less than a predetermined maximum number of transaction service threads being present.

Another configuration of the present invention provides a computing apparatus having a central processing unit operatively coupled to a memory including a database change queue, the apparatus configured to process a plurality of treads capable of being in active, non-active, and waiting states, the apparatus further configured to: (a) add a database change to a top of the database change queue; and (b) add a non-active transaction service thread, or change a waiting transaction service thread to a non-active state, conditioned upon whether there are less than, or not less than a predetermined maximum number of transaction service threads present, respectively.

In yet another configuration of the present invention, there is provided A machine-readable medium or media having recorded thereon instructions configured to instruct a computing apparatus having a central processing unit operatively coupled to a memory to: (a) add a database change to a top of the database change queue in the memory; and (b) start a transaction service thread in a non-active state, or change an existing transaction service thread in a waiting state to a non-active state, conditioned upon whether there are less than, or not less than a predetermined maximum number of transaction service threads present, respectively.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a flow chart representing the queuing of database changes and control of transaction service threads in one configuration of the present invention.

FIG. 2 is a flow chart representing a transaction service thread that processes database changes in one configuration of the present invention.

FIG. 3 is a representation of a computing apparatus and a medium or media of one configuration of the present invention.

### DETAILED DESCRIPTION OF THE PREFERRED EMBODIMENTS

The following description of the preferred embodiment(s) is merely exemplary in nature and is in no way intended to limit the invention, its application, or uses.

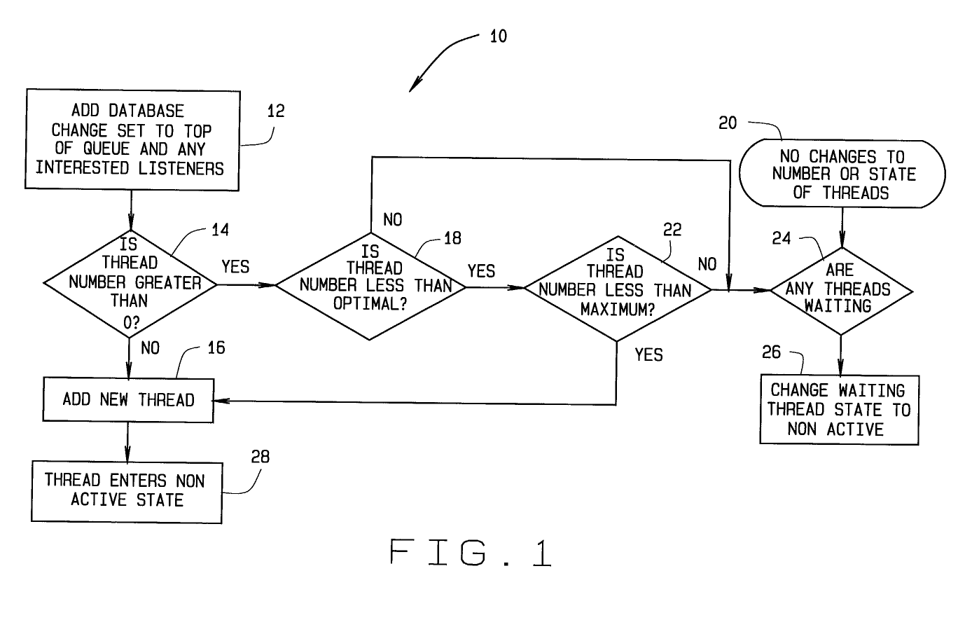

In one embodiment and referring to FIG. 1, database changes are added to a queue and handled by a thread running in a computing apparatus. More particularly, in configuration 10, when a database change is requested, the database change is added 12 to the top of a queue in a memory of the computing apparatus. Depending upon the database change, there may be one or more listeners associated with the change. “Listeners” are programming objects that are notified when the associated change is begun. Listeners are also notified of the completion status of the associated change (e.g., “successful completion,” or “failure”) upon completion of the transaction.

Transactions to the database are performed utilizing “transaction service threads.” A “transaction service thread” is a programming thread executed by a central processing unit of the computing apparatus. Transaction service threads can be in an active state, a non-active state, or a waiting state. An active transaction service thread is a thread that is in the process of handling a set of database changes specified by a queued database change. A non-active thread is a thread that is in the process of attempting to service the queue of database changes. A waiting thread is a thread that is waiting to be triggered into a non-active state.

After placing 12 the database change on top of the queue together with any associated interested listeners, a determination is made 14 as to whether the number of existing transaction service threads is greater than zero. If not, a new transaction service thread 16 is added. Otherwise, in one configuration, a determination is made 18 as to whether the number of existing transaction service threads is less than a dynamically determined optimum number of transaction service threads. A “dynamic determination” of a parameter utilizes current values of variables upon which the parameter is dependent in making the determination. A different value may be found for the parameter each time the parameter is determined. For example, the optimum number of transaction service threads is dependent upon a ratio of an arrival rate of database changes to the queue divided by a service time of items removed from the queue, and in one configuration, the optimum number of transaction service threads is equal to this ratio.

If determination 18 is that the number of transaction service threads is not less than optimum, a check 24 is performed to determine whether there are any threads waiting. If so, a waiting thread is changed 26 to non-active state, or if not, no change is made 20 to the number or state of transaction service threads. Otherwise, a further determination is made 22 to as to whether the number of transaction service threads is less than a predetermined maximum. (The predetermined maximum may, for example, be “hard coded” or be provided as input during initialization of process 10.) if the number is determined to be less than the predetermined maximum, a new thread is added 16. Otherwise, if any transaction service threads are waiting 24, the state of one of the waiting transaction service threads is changed 26 to non-active. If no transaction service thread is waiting, no change 20 is made to the number or state of the transaction service threads.

In each case in which a new transaction service thread is added 16, that thread is placed into a non-active state 28. From this state, the new transaction service thread attempts to service the queue.

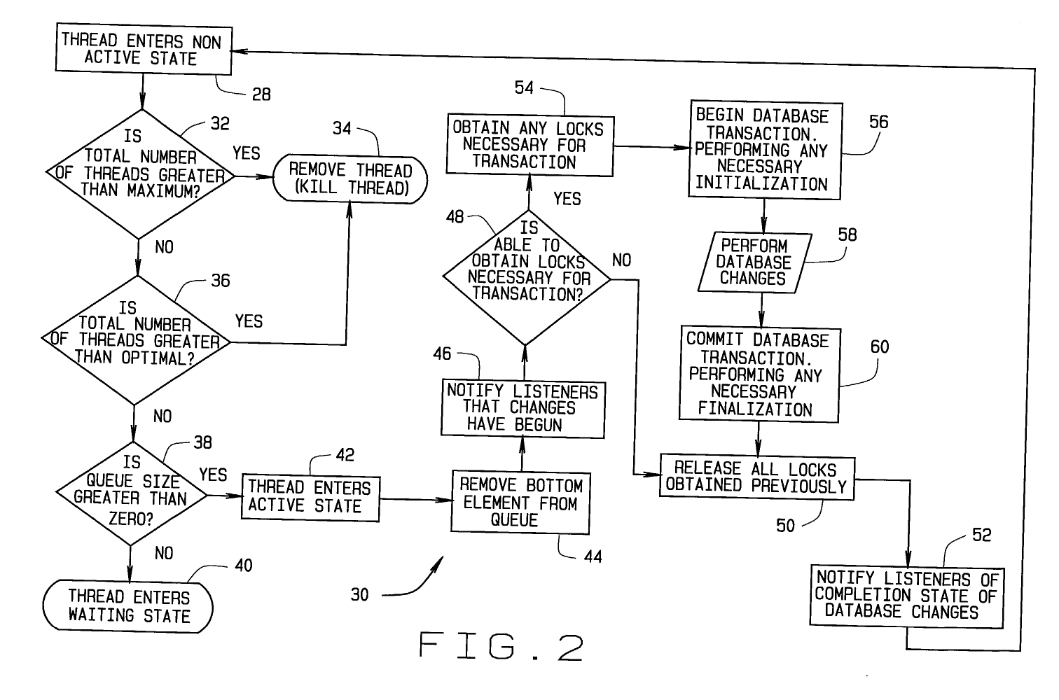

Referring to FIG. 2, a flow chart 30 of one configuration of a transaction service thread that has just been placed in a non-active state 28 is shown. After entering non-active state 28, a determination is made 32 as to whether the total number of threads is greater than the predetermined maximum. If so, the thread is removed 34 (i.e., killed.) Otherwise, a test is performed to determine 36 whether the total number of transaction service threads is greater than a dynamically determined optimum number, determined in the same manner as described above at determination 18 in FIG. 1. (These checks are necessary because additional transaction service threads may have been added by queuing process 10 since the thread entered 28 the non-active state, or while a transaction was being processed 38, 42, 44, 46, 48, 54, 56, 58, 60, 50, 52 by the thread.) If the determination is made that the number of transaction service threads is greater than optimum, the thread is removed 34. (In this configuration, it is thus possible, under certain conditions, for a thread placed 28 in a non-active state by process 10 to terminate itself 34 before it has checked the queue or processed any database changes.) Thus, a thread is removed conditioned on there being more than the lesser of a predetermined maximum number or a dynamically determined optimum number of transaction service threads present.

If the total number of transaction service threads is less than the predetermined maximum and not greater than optimum, the thread determines 38 whether the queue size (i.e., the number of database changes) is greater than zero. If not, the thread enters 40 a waiting state. Waiting transaction service threads are ready and waiting to be triggered to a nonactive state at step 26 of process 10, as shown in FIG. 1.

If the queue size is greater than zero, the transaction service thread enters 42 an active state to process a database change in the queue. In the active state, the transaction service thread removes 44 the bottom element from the queue. The bottom element is the oldest remaining database change that is in the queue at the time of removal. In one configuration, the corresponding set of interested listeners is also removed, if any associated interested listeners were placed on the queue along with the database change. Any such listeners are then notified 46 that changes to the database indicated by the queued database change have begun. If there is no set of listeners corresponding to the removed database change, no listeners are notified at 46.

A database locking mechanism may be used to restrict access to the data source (e.g., a database server). The choice of a suitable locking mechanism is a design choice that may be made by one of ordinary skill in the art. In one configuration in which a database locking mechanism is used, a determination is made 48 as to whether the transaction service thread is able to obtain the locks (i.e., the permission) necessary to perform the transaction specified in the database change that was removed from the bottom of the queue. If not, the transaction is not performed, any locks that may have been obtained are released 50 to permit other transactions to proceed. If any listeners were also taken from the queue, these listeners are notified 52 of the completion state of the database change, i.e., a completion state corresponding to “failure” is sent to the listeners. The transaction service thread then re-enters the non-active state 28 and attempts to process another database change from the bottom of the queue.

If it is determined 48 that locks can be obtained for the transaction, the locks are obtained 54 and the database transaction is begun 56, such as by performing any necessary initialization steps. For example, in one configuration, the transaction service thread runs in a client computing apparatus separate from a database server machine, and a session must be set up before the transaction can take place. After initialization is complete, the transaction is performed 58 and committed 60, and any necessary finalization is performed. All locks previously obtained are then released 50, and any listeners removed from the bottom of the queue are notified 52 of the completion state of the database changes. Usually, a “success” message is sent to the listeners in this case, but “failure” would be sent if the transaction could not be completed and/or committed for any reason. The transaction service thread then re-enters the non-active state 28 and attempts to process another database change from the bottom of the queue.

It is significant that, in FIG. 1, threads may be added 16 to the total number of transaction service threads, while in FIG. 2, threads may be removed 34 from the total number of transaction service threads. Thus, it is possible to dynamically change the optimum number of threads based upon a ratio of arrival rate to service rate, and to dynamically change an optimum size of the threads. For example, while at one time it may be determined that eight transaction service threads is an optimum number, after a time it may be determined that five transaction service threads is optimum. By providing for the addition 16 of threads in FIG. 1 and the removal 34 of threads in FIG. 2, the total number of transaction service threads can be kept to a minimum number necessary to successfully service the transaction queue, or to any other appropriate number.

In one configuration of the present invention, object-oriented programming techniques are used for implementation. A TaskedQueue is provided as an expanded thread pool that includes the concept of listeners and that can find an optimum number of service threads to perform work. Each service thread takes Java Runnables (a class that can be run in a separate thread) or Abortables (a class that can be run in a separate thread and safely aborted). Optimizations provide that, if possible given a specified maximum, the TaskQueue will use the minimum number of threads (system resources) necessary to continually service the queue. This optimization prevents the queue from being over serviced or allowed to grow faster than it can be serviced. A TransactionQueue is provided as a specialized TaskedQueue in which each service thread is configured for handling database transactions.

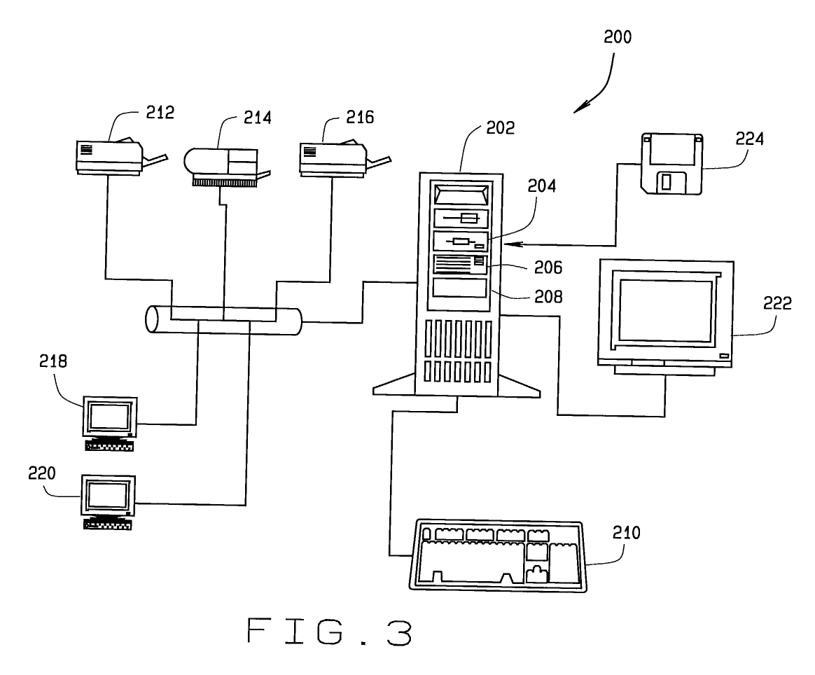

An example of a computing apparatus 200 configured to operate in accordance with the above description is represented in FIG. 3. Cabinet 202 houses a central processing unit (CPU) and associated random access memory (neither of which are shown separately in FIG. 6). In addition to random access memory, the CPU also communicates with other memory storage devices, for example, floppy disk drive 204, hard disk drive 206, and CD-ROM drive 208. A keyboard 210 is also provided. In one configuration, computing apparatus 200 is a database server. Computing apparatus system 200 in one configuration also includes a plurality of devices such as printers 212, 214, and 216 that can be used for printing data. In one configuration, users enter database changes at the CPU housed in cabinet 202, for example via keyboard 210. In another configuration, users communicate database changes to the CPU housed in cabinet 202 via terminals 218, 220, and 222, which can be computers running database client software. In one configuration, machine readable instructions configured to control server 202 CPU and/or computers 218, 220, and 222 to execute the steps and procedures described herein are recorded on one or more media 224, for example, one or more floppy diskettes or CD-ROMS. It is important to note that “computing apparatus” as used herein is intended to be construed in a general sense, in that the term may, in general, refer to a computer network 200 such as illustrated in FIG. 3, or to an individual computer such as represented by 202, 218, 220, or 222. Also, the term “machine readable medium or media having instructions recorded thereon” is used in recognition of the fact that many computer programs or collections of programs intended to instruct a computing apparatus to perform a task are supplied on more than a single diskette, CD-ROM, or other physical medium, or even on combinations of different types of physical media (e.g., a diskette and a CD-ROM). Whether a program is supplied on a medium or on media may depend upon the number and length of the instructions needed on the medium or media or upon design choices made by one of ordinary skill in the art.

It will thus be seen that configurations of the present invention efficiently handle the overhead of performing database transactions as well as efficiently manage resources related to the database. In particular, the queuing mechanism and the thread management mechanism reduces the likelihood that the database or database server will be “stressed” or “bogged down” with excessive numbers of transactions. In addition, the queuing of interested listeners along with database changes can be done automatically, without requiring users of a database to assume the overhead of managing their own transactions. Configurations of the present invention thus present a database resource to users with reduced likelihood that users will be able to overwhelm database capabilities, and without requiring users to configure each database manipulation as a separate transaction.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A method for optimizing database transaction performance in a database transaction processor having transaction services threads capable of being in active, non-active, and waiting states, said method comprising:
(a) adding a database change to a top of a queue; and
(b) starting a non-active transaction service thread conditioned upon less than a predetermined maximum number of transaction service threads being present.

2. A method in accordance with claim 1 further comprising removing a non-active transaction service thread conditioned upon there being more than the lesser of said predetermined maximum number or a dynamically determined optimum number of transaction service threads present.

3. A method in accordance with claim 1 further comprising changing a waiting transaction service thread to a non-active state, conditioned upon not less than a predetermined maximum number of transaction service threads being present.

4. A method in accordance with claim 1 further comprising:
changing the state of a non-active transaction service thread to active conditioned upon there being a database change in the queue; and
using the active transaction service thread:
removing a bottom database change from the queue;
performing database changes specified by the removed database change; and
placing the transaction service thread into the non-active state.

5. A method in accordance with claim 1 wherein said adding a nonactive transaction service thread is further conditioned upon there being less than a dynamically determined optimum number of transaction service threads.

6. A method in accordance with claim 6 further comprising determining said dynamically determined optimum number of transaction service threads dependent upon a ratio of an arrival rate of database changes to the queue divided by a service time of items removed from the queue.

7. A method in accordance with claim 1 wherein adding a database change to a top of a queue further comprises adding a corresponding set of one or more interested listeners to said queue.

8. A method in accordance with claim 7 further comprising:
changing the state of a non-active transaction service thread to active conditioned upon there being a database change in the queue; and
using the active transaction service thread:
removing a bottom database change and the corresponding set of interested listeners from the queue;
notifying said interested listeners that the removed database change has begun;
performing and committing database changes specified by the removed database change, conditioned upon obtaining locks necessary for transactions required for the removed database change;
notifying said interested listeners of a completion status of the removed database change; and
placing the transaction service thread into the non-active state.

9. A computing apparatus having a central processing unit operatively coupled to a memory including a database change queue, said apparatus configured to process a plurality of treads capable of being in active, nonactive, and waiting states, said apparatus further configured to:
(a) add a database change to a top of the database change queue; and
(b) add a non-active transaction service thread, or change a waiting transaction service thread to a non-active state, conditioned upon whether there are less than, or not less than a predetermined maximum number of transaction service threads present, respectively.

10. An apparatus in accordance with claim 9 further configured to remove a non-active transaction service thread conditioned upon there being more than the lesser of said predetermined maximum number or a dynamically determined optimum number of transaction service threads present, and to determine said dynamically determined optimum number of transaction service threads dependent upon a ratio of an arrival rate of database changes to the queue divided by a service time of items removed from the queue.

11. An apparatus in accordance with claim 9 further configured to:
change the state of a non-active transaction service thread to active conditioned upon there being a database change in the queue; and
using the active transaction service thread:
remove a bottom database change from the queue;
perform database changes specified by the removed database change; and
place the transaction service thread into the non-active state.

12. An apparatus in accordance with claim 9 configured to further condition said adding a non-active transaction service thread upon there being less than a dynamically determined optimum number of transaction service threads, and to determine said dynamically determined optimum number of transaction service threads dependent upon a ratio of an arrival rate of database changes to the queue divided by a service time of items removed from the queue.

13. An apparatus in accordance with claim 9 further configured to add a corresponding set of one or more interested listeners to the top of said queue along with said database change.

14. An apparatus in accordance with claim 13 further configured to:
change the state of a non-active transaction service thread to active conditioned upon there being a database change in the queue; and
using the active transaction service thread:
remove a bottom database change and the corresponding set of interested listeners from the queue;
notify said interested listeners that the removed database change has begun;
perform and committing database changes specified by the removed database change, conditioned upon obtaining locks necessary for transactions required for the removed database change;
notify said interested listeners of a completion status of the removed database change; and
place the transaction service thread into the non-active state.

15. A machine-readable medium or media having recorded thereon instructions configured to instruct a computing apparatus having a central processing unit operatively coupled to a memory to:
(a) add a database change to a top of the database change queue in the memory; and
(b) start a transaction service thread in a non-active state, or change an existing transaction service thread in a waiting state to a non-active state, conditioned upon whether there are less than, or not less than a predetermined maximum number of transaction service threads present, respectively.

16. A medium or media in accordance with claim 15 further having recorded thereon instructions configured to instruct the computing apparatus to remove a non-active transaction service thread conditioned upon there being more than the lesser of said predetermined maximum number or a dynamically determined optimum number of transaction service threads present, and to determine said dynamically determined optimum number of transaction service threads dependent upon a ratio of an arrival rate of database changes to the queue divided by a service time of items removed from the queue.

17. A medium or media in accordance with claim 15 further having recorded thereon instructions configured to instruct the computing apparatus to:
change the state of a non-active transaction service thread to active conditioned upon there being a database change in the queue; and
using the active transaction service thread:
remove a bottom database change from the queue;
perform database changes specified by the removed database change; and
place the transaction service thread into the non-active state.

18. A medium or media in accordance with claim 15 also having recorded thereon instructions configured to instruct the computing apparatus to further condition said adding a non-active transaction service thread upon there being less than a dynamically determined optimum number of transaction service threads, and to determine said dynamically determined optimum number of transaction service threads dependent upon a ratio of an arrival rate of database changes to the queue divided by a service time of items removed from the queue.

19. A medium or media in accordance with claim 15 further having recorded thereon instructions configured to instruct the computing apparatus to add a corresponding set of one or more interested listeners to the top of said queue along with said database change.

20. A medium or media in accordance with claim 19 further having recorded thereon instructions configured to instruct the computing apparatus to:
change the state of a non-active transaction service thread to active conditioned upon there being a database change in the queue; and
using the active transaction service thread:
remove a bottom database change and the corresponding set of interested listeners from the queue;
notify said interested listeners that the removed database change has begun;
perform and committing database changes specified by the removed database change, conditioned upon obtaining locks necessary for transactions required for the removed database change;
notify said interested listeners of a completion status of the removed database change; and
place the transaction service thread into the non-active state.
